(19) United States
(12) Patent Application Publication
(10) Pub. No.: US 2014/0354679 A1
(43) Pub. Date: Dec. 4, 2014

(54) DISPLAY CONTROL METHOD AND DISPLAY DEVICE USING THE DISPLAY CONTROL METHOD

(71) Applicant: FITIPOWER INTEGRATED TECHNOLOGY, INC., Hsinchu City (TW)

(72) Inventor: CHONG-XING WANG, Hsinchu (TW)

(73) Assignee: FITIPOWER INTEGRATED TECHNOLOGY, INC., Hsinchu City (TW)

(21) Appl. No.: 14/140,577

(22) Filed: Dec. 26, 2013

(30) Foreign Application Priority Data
Jun. 3, 2013 (TW) 102119568

(51) Int. Cl. G09G 5/02

(52) U.S. Cl. CPC G09G 5/02
USPC 345/604

(57) ABSTRACT

A display control method of a display device involves detecting color characteristic parameters of one or more images to be displayed. The color characteristic parameters include RGB values that are compared with predetermined RGB values to obtain a comparison result. A working status of the color engine is controlled according to the comparison result.

### BACKGROUND

1. Technical Field

The present disclosure relates to a display control method and a display device using the display control method.

2. Description of Related Art

A color engine, which is also called a color management module (CMM), is widely used in display devices, such as smart phones, tablet personal computers, or the like. The color engine processes every image to be displayed to increase a sharpness and brightness of the displayed image. However, even if the image to be displayed is sharp and clear, the image is still processed by the color engine, which wastes power of the display device.

Therefore, what is needed is a means to overcome the above-described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of an embodiment of a display device having a display control system.

FIG. 2 shows an embodiment of a parameter setting interface of the display device of FIG. 1.

FIG. 3 is a flowchart of one embodiment of a display control method of the display device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

Reference will be made to the drawings to describe various embodiments.

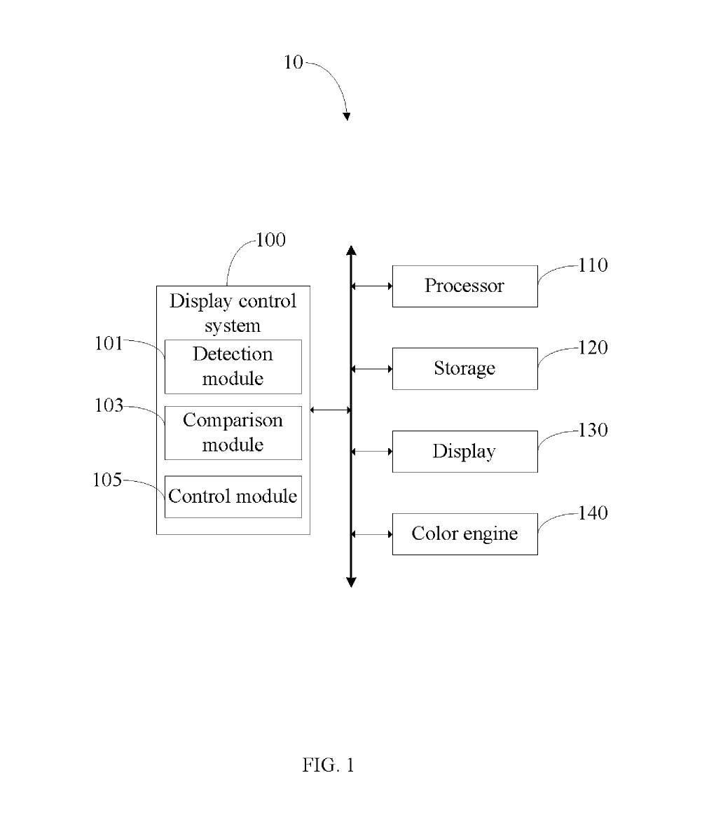

FIG. 1 is a schematic block diagram of an embodiment of a display device 10, which includes a display control system 100. The display device 10 further includes a processor 110, a storage 120, a display 130, and a color engine 140. The display device 10 can be a smart phone, a mobile Internet device (MID), or other similar device. FIG. 1 shows one example of the display device 10, and the display device 10 can include more or fewer components than those shown in the figure, or have a different configuration of the components. The color engine 140 converts RGB color space of an image into HSI color space, where R represents red, G represents green, B represents blue, H represents hue, S represents saturation, and I represents intensity. The color engine 140 modulates the hue, saturation, or intensity of the image displayed on the display 130 to make the images displayed on the display device 10 sharper and clearer, thereby increasing visual quality of the displayed images.

The display control system 100 can include a plurality of programs in the form of one or more computerized instructions stored in the storage 120 and executed by the processor 110 to perform operations of the display device 10. In one embodiment, the display control system includes a detection module 101, a comparison module 103, and a control module 105. In general, the word “module”, as used herein, refers to logic embodied in hardware or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The detection module 101 detects color characteristic parameters of one or more images to be displayed on the display 130. The color characteristic parameters comprise RGB values of the one or more images. The RGB values comprise an R value, a G value, and a B value of the one or more images. In one embodiment, the detection module 101 obtains the RGB values via a specific software program, such as a color extractor program of a Photoshop® application.

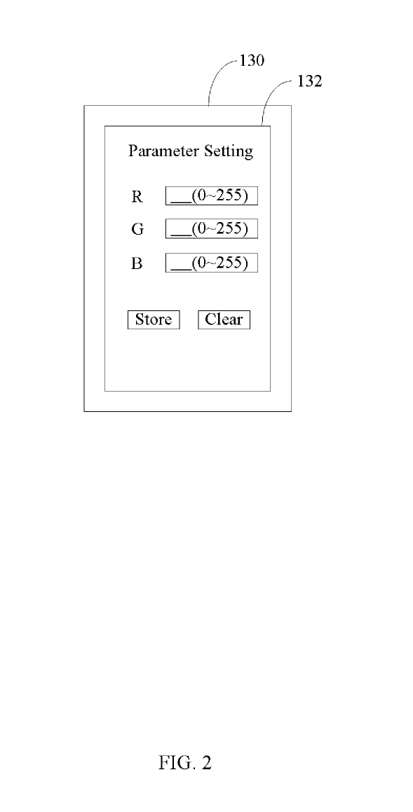

The comparison module 103 compares the RGB values of the images with corresponding predetermined RGB values and outputs a comparison result. The predetermined RGB values comprise a predetermined R value, a predetermined G value, and a predetermined B value, each of which is stored in the storage 120. The predetermined RGB values are set within a value range of 0-255. In one embodiment, as shown in FIG. 2, the display device 10 provides a parameter setting interface for manually setting the predetermined RGB values.

The parameter setting interface 132 is activated by an application icon displayed on the display 130 or by a physical key arranged on the display device 10. The parameter setting interface 132 includes RGB brightness parameter boxes for setting the R value, G value, and B value. The predetermined RGB values are input into the RGB brightness parameter boxes via an input/output (I/O) device (not shown) such as a touch panel or a keyboard of the display device 10.

The control module 105 controls a working status of the color engine 140 according to the comparison result. In one embodiment, when the comparison result indicates that at least one of the R, G, and B values of the color characteristic parameters of the image is less than the predetermined R, G, and B values, respectively, the color engine 140 is activated by the control module 105 to process the one or more images to be displayed. When the comparison result indicates that each of the R, G, and B values of the color characteristic parameters of the image is greater than the predetermined R, G, and B values, respectively, the color engine 140 is turned off by the control module 105.

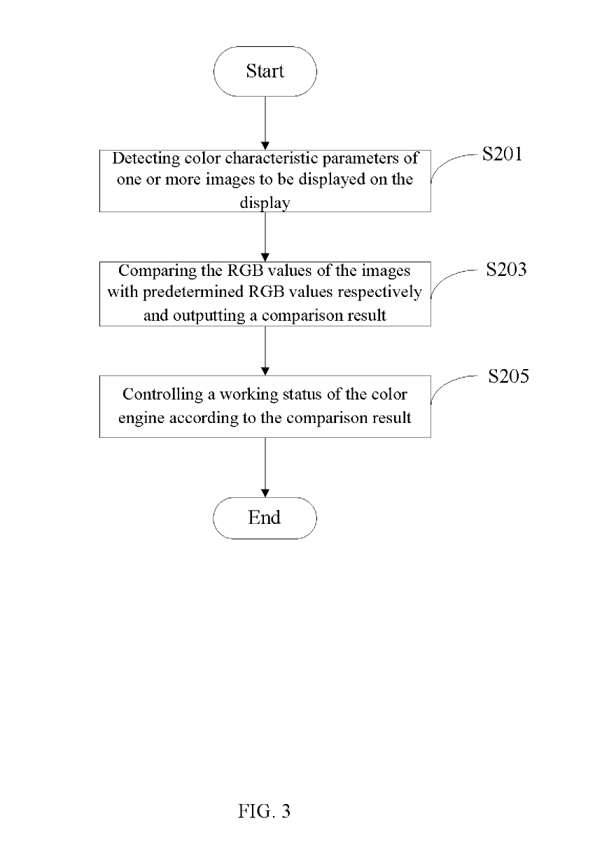

FIG. 3 shows a flowchart of one embodiment of a control method of the display device 10. Depending on the embodiment, additional steps may be added, others removed, and the ordering of the steps may be changed.

In step S201, the detection module 101 detects color characteristic parameters of one or more images to be displayed on the display 130. The color characteristic parameters comprise RGB values. The RGB values comprise an R value, a G value, and a B value. In one embodiment, the detection module 101 obtains the RGB values via a specific software program, such as a color extractor program of a Photoshop® application.

In step S203, the comparison module 103 compares the RGB values of the images with predetermined RGB values and outputs a comparison result. The predetermined RGB values include a predetermined R value, a predetermined G value, and a predetermined B value, each of which is stored in the storage 120. The predetermined RGB values are set within a value range of 0-255.

In step S205, the control module 105 controls a working status of the color engine 140 according to the comparison result. In one embodiment, when the comparison result indicates that at least one of the R, G, and B values of the color characteristic parameters of the image is less than the predetermined R, G, and B values, respectively, the color engine 140 is activated by the control module 105 to process the one or more image to be displayed. When the comparison result indicates that each of the R, G, and B values of the color characteristic parameters of the image is greater than the predetermined R, G, and B values, respectively, the color engine 140 is turned off by the control module 105.

In summary, the control method for the display device 10 automatically detects whether an image needs to be processed by the color engine 140 according to color characteristic parameters of the image. When the image to be displayed does not require to be processed, the color engine 140 is turned off. Thus, the display device 10 consumes less power.

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A display device, comprising:
a processor;
a display;
a storage;
a color engine converting RGB color space of an image into HIS color space, wherein R represents red, G represents green, B represents blue, H represents hue, S represents saturation, and I represents intensity, and modulating hue, saturation, or intensity of the image displayed on the display to make the images displayed on the display device sharper and clearer; and
one or more programs stored in the storage and executed by the processor, the one or more programs comprising:
a detection module detecting color characteristic parameters of one or more image to be displayed on the display, wherein the color characteristic parameters comprise RGB values of the one or more images;
a comparison module comparing the RGB values of the images with predetermined RGB values comprising a predetermined R value, a predetermined G value, and a predetermined B value, respectively, and outputting a comparison result;
a control module controlling a working status of the color engine according to the comparison result, wherein when the comparison result indicates that each of the R, G, and B values of the color characteristic parameters of the image is greater than the predetermined R, G, and B values, respectively, the color engine is turned off by the control module.

2. The display device of claim 1, wherein the RGB values comprises a R value, a G value, and a B value of the one or more image

3. The display device of claim 2, wherein the predetermined R value, the predetermined G value, and the predetermined B value are stored in the storage.

4. The display device of claim 3, wherein the predetermined RGB values are set via a parameter setting interface, the parameter setting interface comprises RGB brightness parameter boxes, and the predetermined values are set via the RGB brightness parameter boxes, respectively.

5. The display device of claim 4, wherein when the comparison result indicates the R value of the color characteristic parameters of the image is less than the predetermined R value, or indicates that the G value of the color characteristic parameters of the image is less than the predetermined G value, or the B value of the color characteristic parameters of the image is less than the predetermined B value, the color engine is activated by the control module to process the image.

6. A control method of a display device having a color engine which converts RGB color space of an image into HIS color space, wherein R represents red, G represents green, B represents blue, H represents hue, S represents saturation, and I represents intensity, and modulates hue, saturation, or intensity of the image displayed on the display to make the images displayed on the display device sharper and clearer, the method comprising:
detecting color characteristic parameters of one or more image to be displayed on the display, wherein the color characteristic parameters comprise RGB values of the one or more images;
comparing the RGB values of the images with predetermined RGB values comprising a predetermined R value, a predetermined G value, and a predetermined B value, respectively, and outputting a comparison result; and
controlling a working status of the color engine according the comparison result, wherein when the comparison result indicates that each of the R, G, and B values of the color characteristic parameters of the image is greater than the predetermined R, G, and B values, respectively, the color engine is turned off.

7. The control method of claim 6, wherein the RGB values comprises a R value, a G value, and a B value of the one or more images.

8. The control method of claim 7, further comprising storing the predetermined R value, the predetermined G value, and the predetermined B value in a storage of the electronic device.

9. The control method of claim 8, further comprising setting the predetermined RGB values via a parameter setting interface, the parameter setting interface comprises RGB brightness parameter boxes, and further comprising setting the predetermined values via the RGB brightness parameter boxes, respectively.

10. The control method of claim 6, further comprising when the comparison result indicates the R value of the color characteristic parameters of the image is less than the predetermined R value, or indicates that the G value of the color characteristic parameters of the image is less than the predetermined G value, or the B value of the color characteristic parameters of the image is less than the predetermined B value, the color engine is activated by the control module to process the image.
